(19) United States
(12) Patent Application Publication
(10) Pub. No.: US 2024/0220213 A1
(43) Pub. Date: Jul. 4, 2024

(54) CONTEXTUAL UI AUTOMATION IN ROBOTIC PROCESS AUTOMATION

(71) Applicant: INTERNATIONAL BUSINESS MACHINES CORPORATION, Armonk, NY (US)

(72) Inventors: Chao Yuan HUANG, Taipei (TW); Yuan Jie ZHANG, Ningbo (CN); Yu Jie GU, Beijing (CN); Yan Xiu WU, Beijing (CN)

(21) Appl. No.: 18/091,585

(22) Filed: Dec. 30, 2022

(51) Int. Cl. G06F 8/34

(52) U.S. Cl. CPC G06F 8/34

(57) ABSTRACT

Aspects of the present disclosure relate generally to UI automation in RPA and, more particularly, to automation of contextual UI element identification by RPA robots. For example, a computer-implemented method includes: receiving, by a processor set, user interface context identification information of attributes of user interface elements in user interface code of an application; constructing, by the processor set, a model of the attributes of the user interface elements including an attribute indicating functionality of at least one user interface element; obtaining from the model of the attributes of the user interface elements an identification of the at least one user interface element referenced in an action command for performing the functionality of the at least one user interface element in robotic process automation code; and storing, by the processor set, the model of the attributes of the user interface elements in persistent storage.

### BACKGROUND

Aspects of the present invention relate generally to user interface (UI) automation in robotic process automation (RPA) and, more particularly, to systems, computer program products, and methods of automation of contextual UI element identification in application UI panels by RPA robots (bots).

Deployment of robotic process automation projects have accelerated across many organizations that change a variety of manual tasks to digital tasks, saving time and money while enhancing productivity. A fundamental technology of RPA is UI element recognition. As RPA automations continue to proliferate, it becomes increasingly critical for existing RPA code to execute properly in RPA automation projects, even in the wake of changed UI elements in new versions of applications.

### SUMMARY

In a first aspect of the invention, there is a computer-implemented method including: receiving, by a processor set, user interface context identification information of attributes of user interface elements in user interface code of an application; constructing, by the processor set, a model of the attributes of the user interface elements including an attribute indicating functionality of at least one user interface element; obtaining from the model of the attributes of the user interface elements an identification of the at least one user interface element referenced in an action command for performing the functionality of the at least one user interface element in robotic process automation code; and storing, by the processor set, the model of the attributes of the user interface elements in persistent storage.

In another aspect of the invention, there is a computer program product including one or more computer readable storage media having program instructions collectively stored on the one or more computer readable storage media. The program instructions are executable to: construct a model of attributes of user interface elements in user interface code including an attribute indicating functionality of at least one user interface element; obtain from the model of the attributes of the user interface elements an identification of the at least one user interface element referenced in an action command for performing the functionality of the at least one user interface element in robotic process automation code; generate robotic process automation code referencing the at least one user interface element identified in the model of the attributes of the user interface elements; build a robotic process automation robot deployable in a production environment using the generated robotic process automation code; and deploy the robotic process automation robot in the production environment.

In another aspect of the invention, there is a system including a processor set, one or more computer readable storage media, and program instructions collectively stored on the one or more computer readable storage media. The program instructions are executable to: execute an action command in robotic process automation code referencing a user interface element of a previous version of an application; receive an indication of failure to identify the user interface element during execution of the action command in the robotic process automation code using an updated version of the application; construct a model of attributes of user interface elements in user interface code of the updated version of the application including an attribute indicating functionality of at least one updated user interface element; identify from the model of the attributes of the user interface elements the at least one updated user interface element that performs the functionality of the user interface element; and continue execution of the action command in the robotic process automation code to perform the functionality of the at least one updated user interface element.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIGS. 3A-3C depict illustrations of exemplary UI element changes in accordance with aspects of the invention.

FIG. 4 depicts an illustration of an exemplary process flow diagram in accordance with aspects of the invention.

FIGS. 5A-5B depict illustrations of exemplary process flow diagrams in accordance with aspects of the invention.

FIG. 6 depicts an illustration of an exemplary process flow diagram in accordance with aspects of the invention.

FIG. 7 shows a flowchart of an exemplary method in accordance with aspects of the invention.

FIG. 8 shows a flowchart of an exemplary method in accordance with aspects of the invention.

FIG. 9 shows a flowchart of an exemplary method in accordance with aspects of the invention.

### DETAILED DESCRIPTION

Aspects of the present invention relate generally to user interface (UI) automation in robotic process automation (RPA) and, more particularly, to systems, computer program products, and methods of automation of contextual UI element identification in application UI panels by RPA robots (bots). More specifically, aspects of the invention relate to methods, computer program products, and systems for identifying context attributes of UI elements in UI panels of applications, constructing UI context snapshot models from the context attributes of UI elements, and optimizing generation and execution of robotic process automation code using the UI context snapshot models. An inefficient and inconsistent process occurs when a version of the UI is changed in applications. RPA bots that perform digital tasks using the applications are unable to locate some changed UI elements and consequently fail during execution. Script modifications are typically required by RPA developers for the RPA bots to properly execute again. As a result, changing UI elements in versions of applications can significantly increase development and maintenance costs for performing digital tasks. According to aspects of the invention, the methods, systems, and computer program products described herein automatically locate updated UI elements in new versions of applications and allow the bots to continue execution when UI elements in previous versions of applications are changed in the new versions of applications.

In embodiments, the methods, systems, and program products described herein receive UI code of a UI panel of an application, scan the UI code of the UI panel, identify UI context attributes specified in the UI code, collect UI context identification information for UI context attributes and construct the UI context snapshot model. The methods, systems, and program products of the present invention optimize UI automation in generating bots by easily locating UI elements on UI panels of applications via the UI context snapshot model and providing the identification of UI elements for action commands input to a script generator writing RPA code for the action commands. The methods, systems, and program products of the present invention provide a failover capability that automatically locates updated UI elements in new versions of applications when bots execute action commands referencing UI elements changed from previous versions of applications. Upon receiving an indication of failure to identify a UI element during execution of the action command in the RPA code using an updated version of the application, the methods, systems, and program products of the present invention construct a model of attributes of UI elements in UI code of the updated version of the application, identify from the model of the attributes of the UI elements an updated UI element that performs the functionality of the UI element from the previous version, and continue execution of the action command in the RPA code to perform the functionality of the updated UI element.

Aspects of the present invention are directed to improvements in computer-related technology and existing technological processes for UI automation in bots. In embodiments, the methods, computer program products, and systems may receive UI code specifying attributes of UI elements of an application, identify attributes of the UI elements in the UI code, construct a model of the attributes of the UI elements in the UI code, obtain an identification of a UI element referenced in an action command for performing the functionality of the UI element in robotic process automation code, and generate RPA code referencing the UI element identified in the model of the attributes of the UI elements. Advantageously, the methods, computer program products, and systems optimize UI automation in generating bots by easily locating UI elements on UI panels of applications via the UI context snapshot model and providing the identification of UI elements for action commands input to a script generator writing RPA code for the action commands. These are specific improvements in the way computers may operate and interoperate for UI automation in bots.

Implementations of the disclosure describe additional elements that are specific improvements in the way computers may operate and these additional elements provide non-abstract improvements to computer functionality and capabilities. As an example, the methods, computer program products, and systems describe a UI context attributes identification module, UI context snapshot module, UI locator module, script executor module, UI re-matcher module, and script generator module that may execute an action command in RPA code referencing a UI element of a previous version of an application, receive an indication of failure to identify the UI element during execution of the action command in the RPA code using an updated version of the application, construct a model of attributes of UI elements in UI code of the updated version of the application, identify from the model of the attributes of the UI elements an updated UI element that performs the functionality of the UI element, and continue execution of the action command in the RPA code to perform the functionality of the updated UI element. The additional elements of the methods, computer program products, and systems of the present invention are specific improvements in the way computers may operate to automate failover of UI automation by automatically locating updated UI elements in new versions of applications and allowing RPA bots to continue execution when UI elements in previous versions of applications are changed in the new versions of applications.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as contextual UI automation in robotic process automation code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

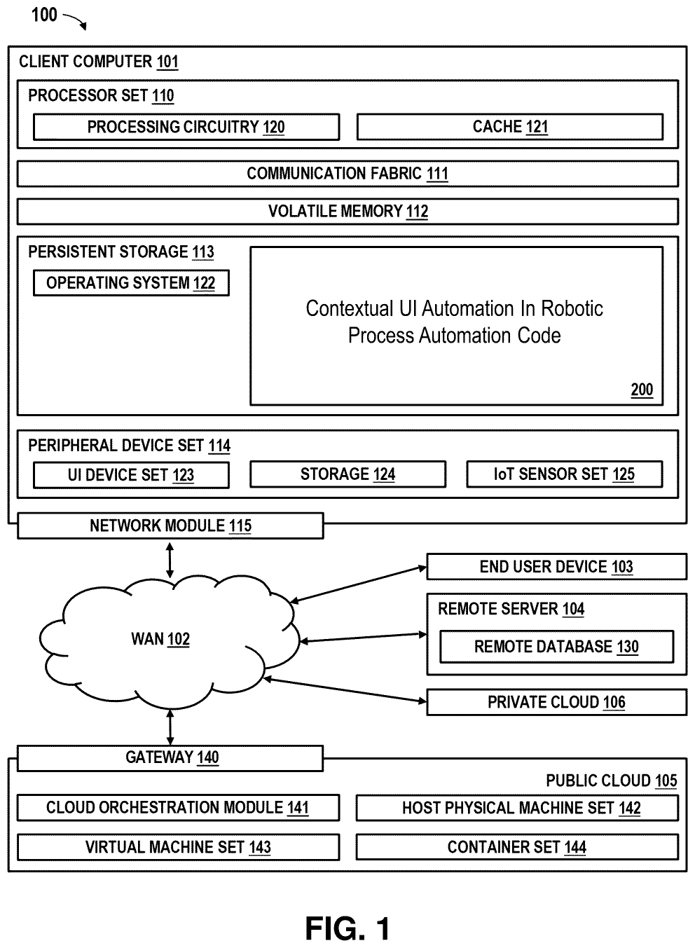

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

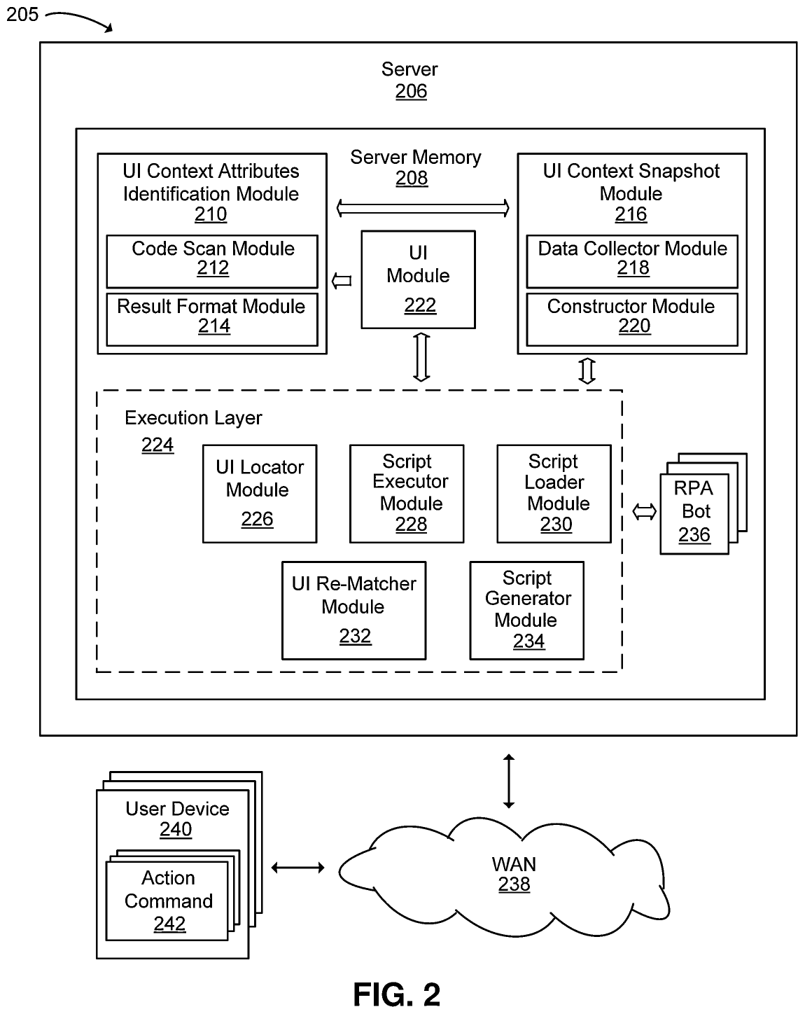

FIG. 2 shows a block diagram of an exemplary environment 205 in accordance with aspects of the invention. In embodiments, the environment includes a server 206, which may be a computer system such as a computer 101 described with respect to FIG. 1 with which end user devices 103 and remote servers 104, each also described with respect to FIG. 1, may communicate over a network such as WAN 102 described with respect to FIG. 1. In general, server 206 supports services for automation of contextual UI element identification by bots.

Server 206 has a server memory 208 such as volatile memory 112 described with respect to FIG. 1. Server 206 includes, in memory 208, UI context attributes identification module 210 having functionality to receive UI code of a UI panel of an application, collect context identification information for UI context attributes of UI elements, format UI context identification information results, and send the UI context identification information results to build a UI context snapshot module, among other functionality in embodiments. The UI context attributes identification module 210 may include in embodiments code scan module 212 having functionality to scan UI code of the UI panel of the application and identify UI context attributes in the UI code. The UI context attributes identification module 210 may include in embodiments result format module 214 having functionality to format UI context identification information results. For instance, the UI context identification information includes UI context attributes in embodiments from an HTML document such as element type, element coordinate information, element label, element event type, element event handler, element data dependency, element event dependency, element parent relationship, element children relationships, element peer relationships, and element metadata such as style, XPath, Id, tag name, and so forth.

Server 206 includes UI context snapshot module 216 having functionality to receive the UI context identification information results and build a UI context snapshot model. The UI context snapshot module 216 may include in embodiments data collector module 218 having functionality to collect UI context attributes from the UI context attributes identification module 210. The UI context snapshot module 216 may also include in embodiments constructor module 220 having functionality to build the UI context snapshot model from the UI context attributes. In embodiments, the constructor module 220 may build a representation of the UI context snapshot model using UI panel information, UI elements identification information and the UI elements relationships to parent, children and peer UI panels.

Server 206 further includes, in memory 208, UI module 222 having functionality to receive user interface code for UI panels of an application, for instance from an application executing on a user device such as user device 240 or from an application executing in server memory 208 and sending the user interface code to the UI context attributes identification module 210. For example, the user interface code for UI panels of an application may be specified by HTML code. Those skilled in the art should appreciate that other types of user interface code with specifications of UI element attributes may be used such as other markup languages including extensible markup language, standard generalized markup language, and so forth. In embodiments, the UI module 222 has further functionality to receive user interface code for UI panels of an application from an application executing on the user device 240 or from an application executing in server memory 208 and sending the user interface code to the execution layer 224 during execution of a bot.

Server 206 additionally includes, in memory 208, execution layer 224 with modules that optimize UI automation in bots and implement failover capabilities enabling bots experiencing an exception during execution for unidentifiable UI elements in new versions of applications to locate the UI elements in the new versions of applications and continue execution. The modules of the execution layer 224 may include UI locator module 226, script executor module 228, script loader module 230, UI re-matcher module 232, and script generator module 234. UI locator module 226 has functionality that locates UI elements on a UI panel by accessing the UI context snapshot module 216 of UI context attributes of UI elements. UI locator module 226 optimizes UI automation in generating bots by easily locating UI elements on a UI panel via access of the UI context snapshot module 216. Script executor module 228 has functionality that executes automation scripts like RPA bot 236 loaded by script loader module 230.

Continuing with the modules of the execution layer 224, UI re-matcher module 232 has functionality that requests a new UI context snapshot model of a UI panel, compares the new UI context snapshot model of the UI panel with the previous UI context snapshot model of the UI panel, and identifies UI elements in the new context snapshot model with similar functionality as UI elements in the previous snapshot model. The UI re-matcher module 232 supports failover during execution of a bot when an exception occurs for unidentifiable UI elements in new versions of applications. The UI re-matcher module 232 locates the UI elements in the new versions of applications and allows the bot to continue execution. Script generator module 234 has functionality to generate script code for updating bots with replacement scripts to identify and locate the UI elements in new versions of applications.

In embodiments, server 206 of FIG. 2 comprises UI context attributes identification module 210, UI context snapshot module 216, UI module 222, UI locator module 226, script executor module 228, script loader module 230, UI re-matcher module 232, and script generator module 234, each of which may comprise modules of the code of block 200 of FIG. 1. These modules of the code of block 200 are executable by the processing circuitry 120 of FIG. 1 to perform the inventive methods as described herein. Server 206 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the environment 205 of FIG. 2 also shows user device 240 which may be a computer system such as end user device 103, described with respect to FIG. 1, that may communicate over WAN 238 which may be a wide area network such as WAN 102, described with respect to FIG. 1. User device 240 may execute action commands 242 input by a user for manually performing a task using applications. An action command is a command or programmed actions typically written in RPA code as keywords and programmed actions for performing a task. To generate a digital task, the action commands 242 and associated UI code for UI panels of applications may be sent to the UI module 222 which, in turn, are provided to the UI context attributes identification module 210 to identify UI context attributes in the UI code for the UI panels. The UI context attributes are sent to the UI context snapshot module 216 to build a UI context snapshot model. The UI locator module 226 optimizes UI automation in generating bots by easily locating UI elements on a UI panel via access of the UI context snapshot module 216 and providing the identification of UI elements for the action commands to the script generator module 234. The script generator module 234 receives the action commands from the UI module 222 and the identification of UI elements for the action commands from the UI locator module 226 and generates an automation script like RPA bot 236.

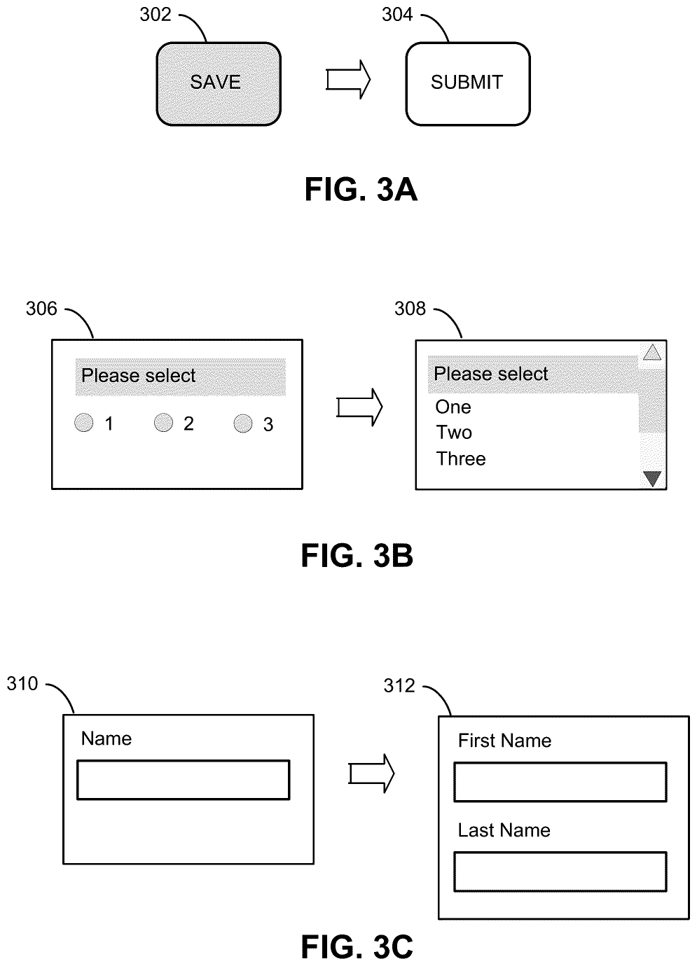

FIGS. 3A-3C depict illustrations of exemplary UI element changes in accordance with aspects of the invention. The exemplary UI element change of FIG. 3A illustrates the change of a SAVE button 302 for instance in a previous version of an application to a SUBMIT button 304 in a new version of the application. In this example, the element label, element style, and element location attributes may be different for these UI elements, but the event type and event handler attributes of the UI element of the SUBMIT button 304, for example, are the same as the event type and event handler attributes of the UI element of the SAVE button 302 in the previous version of the application. During execution of an action command of a bot for the new version of the application, an exception occurs for the unidentifiable UI element of the SAVE button 302 in the UI panel of the new version of application. In this example, the UI re-matcher module 232 described with respect to FIG. 2 can locate the UI element of the SUBMIT button 304 in the new version of the application and allow the bot to continue execution. In this way, aspects of the present invention provide a failover capability for bots when there are changes to UI elements in UI panels of applications used by bots.

The exemplary UI element change of FIG. 3B illustrates the change of a radio button group 306 for instance in a previous version of an application to a drop down list 308 in a new version of the application. In this example, both UI elements may have the same element type for single selection, the same parent and peer element, and the label may indicate the drop down list is a replacement of the radio button group in the previous version of the application. In this example, the UI re-matcher module 232 described with respect to FIG. 2 can locate the UI element of the drop down list 308 in the new version of the application and allow the bot to continue execution when an exception occurs during execution for the unidentifiable UI element of the radio button group 306 in the UI panel of the new version of application.

The exemplary UI element change of FIG. 3C illustrates the change of a single text input box 310 for input of a name in a previous version of an application to two text input boxes 312 for input of a first name and input of a last name in a new version of the application. In this example, the second text input box for input of a last name may have the same element type, same data dependency and same parent as its peer element, the first text input box of the two text input boxes 312. In this example, the UI re-matcher module 232 described with respect to FIG. 2 can locate the two text input boxes 312 as the UI element for the single text input box 310 and the script generator module 234 treats the second text input box as an additional input element with similar context attributes as the first text input box of the two text input boxes 312 in generating replacement script code for the automation script for the single text input box 310 of the previous application.

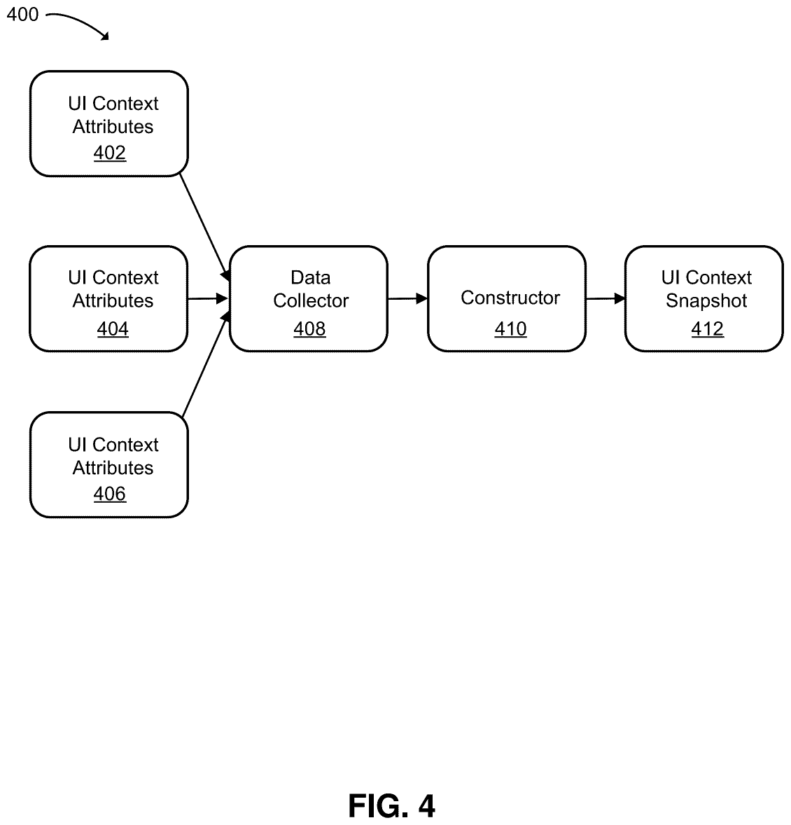

FIG. 4 depicts an illustration of an exemplary process flow diagram in accordance with aspects of the invention. The process flow diagram of FIG. 4 illustrates the process flow 400 in embodiments for generating a UI context snapshot model from UI context attributes. UI context attributes 402, 404, and 406 shown in FIG. 4 are characteristics of UI elements that are defined for instance in embodiments in an HTML document such as element type, element coordinate information, element label, element event type, element event handler, element data dependency, element event dependency, element parent relationship, element children relationships, element peer relationships, and element metadata such as style, XPath, Id, tag name, and so forth. In embodiments, these context attributes may be identified as UI context attributes identification information along with UI panel information and the UI elements relationships to parent, children and peer UI panels by the UI context attributes identification module 210 described with respect to FIG. 2. Data collector 408 shown in FIG. 4 represents data collector module 218 described with respect to FIG. 2 that collects UI context attributes sent by the UI context attributes identification module 210 described with respect to FIG. 2. Data collector 408 shown in FIG. 4 sends the UI context attributes identification information to constructor 410 to build the UI context snapshot model.

The constructor 410 shown in FIG. 4 represents constructor module 220 described with respect to FIG. 2. Constructor 410 builds the UI context snapshot 412 from the UI context attributes identification information. In embodiments, the constructor 410 may build a representation of the UI context snapshot 412 using UI context attributes identification information along with UI panel information and the UI elements relationships to parent, children and peer UI panels. The UI context snapshot 412 may be represented in embodiments by a relationship graph of UI elements as nodes connected by edges representing the relationship to other UI elements and/or to UI panels such as parent, child, or peer, for instance. Each node is associated with a template populated with context attributes in embodiments such as element coordinate information, element label, element event type, element event handler, among other context attributes of the UI element. Those skilled in the art should appreciate that other representations of the UI context snapshot 412 may be implemented in embodiments including a data table of UI element context attributes, an associative array of UI elements and context attributes, or other representation.

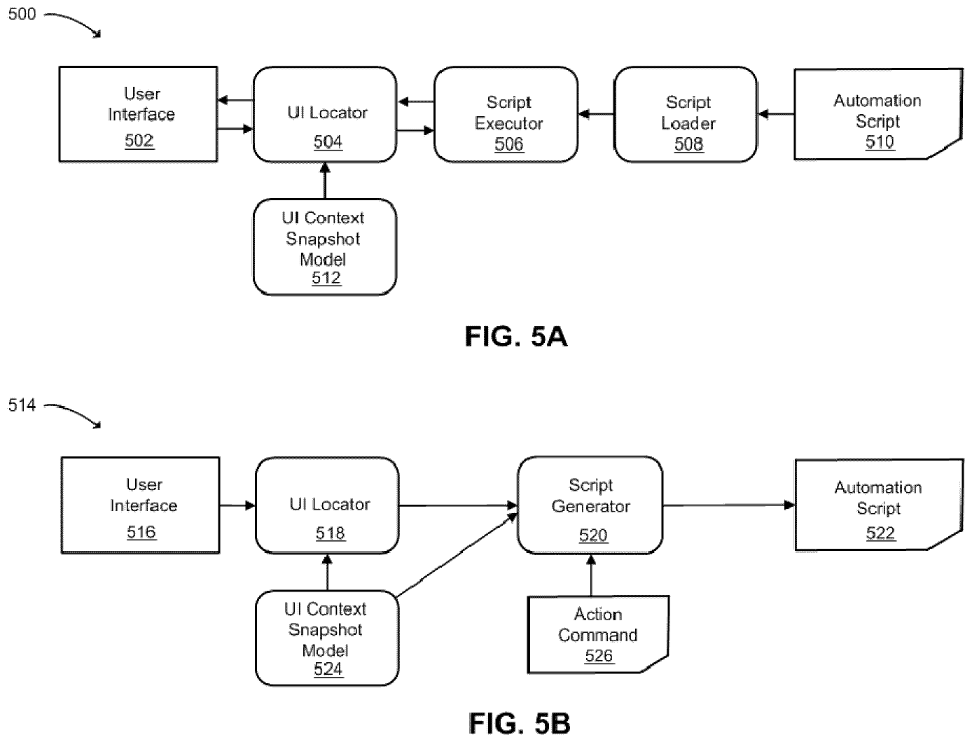

FIGS. 5A-5B depict illustrations of exemplary process flow diagrams in accordance with aspects of the invention. The process flow diagram of FIG. 5A illustrates the exemplary process flow 500 in embodiments for executing an automation script 510 using the UI context snapshot model 512. The script loader 508, which represents script loader module 230 described with respect to FIG. 2, may load automation script 510 for execution. The script executor 506, which represents script executor module 228 described with respect to FIG. 2, executes the automation script 510. Whenever an action command in the automation script 510 references a UI element during execution, the script executor 506 requests the UI locator 504, which represents UI locator module 226 described with respect to FIG. 2, to provide the identification of the UI element on the UI panel of the application in use and referenced by the action command.

The UI locator 504 requests information for UI context attributes of the UI element from the UI context snapshot model 512, which represents UI context snapshot module 216 described with respect to FIG. 2, and can request user interface code for UI panels of the application from the user interface 502, which represents UI module 222 described with respect to FIG. 2. The information for UI context attributes of the UI element is sent from the UI context snapshot model 512 to the UI locator 504 and the UI locator 504 provides the information for UI context attributes of the UI element to the script executor 506 as requested. The script executor 506 uses the information for UI context attributes of the UI element to execute the action command referencing the UI element. In this way, the present invention optimizes finding UI elements during automation execution.

The process flow diagram of FIG. 5B illustrates the process flow 514 in embodiments for generating an automation script 522 from an action command 526 using the UI context snapshot model 524, which represents UI context snapshot module 216 described with respect to FIG. 2. An action command 526 referencing a UI element of an application in use may be received by the script generator 520, which represents script generator module 234 described with respect to FIG. 2, and UI code of the application in use and referenced by the action command may be sent from user interface 516, which represents UI module 222 described with respect to FIG. 2, to UI locator 518, which represents UI locator module 226 described with respect to FIG. 2. Information for UI context attributes of the UI element is sent from the UI context snapshot model 524 to the UI locator 518 and to the script generator 520. The script generator 520 uses the information for UI context attributes of the UI element to write script code for performing the action command referencing the UI element in the automation script. In this way, the present invention optimizes finding UI elements during generation of an automation.

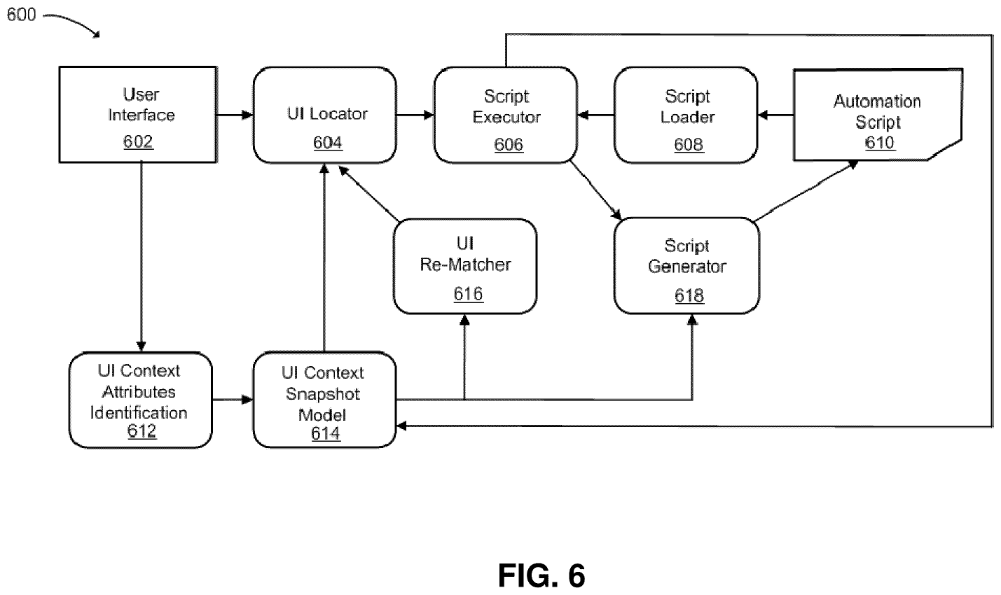

FIG. 6 depicts an illustration of an exemplary process flow diagram in accordance with aspects of the invention. The process flow diagram of FIG. 6 illustrates the process flow 600 in embodiments for failover of an executing automation script 610 using the UI context snapshot model 614, which represents UI context snapshot module 216 described with respect to FIG. 2. The script loader 608, which represents script loader module 230 described with respect to FIG. 2, may load automation script 610 for execution and the script executor 606, which represents script executor module 228 described with respect to FIG. 2, executes the automation script 610. Whenever an action command in the script includes a reference to an unidentifiable UI element of a new version of an application in use by the automation script 610 during execution, the script executor 606 requests the UI re-matcher 616, which represents UI re-matcher module 232 described with respect to FIG. 2, to find the unidentifiable UI element on the UI panel of the new version of the application. UI re-matcher 616 requests a new UI context snapshot model of the UI panel of the new version of the application. The user interface 602, which represents UI module 222 described with respect to FIG. 2, provides the UI code of the UI panel to the UI context attributes identification 612, which represents UI context attributes identification module 210 described with respect to FIG. 2. The UI context attributes identification 612 sends the context attributes of the UI elements on the UI panel to the UI context snapshot model 614 to build the UI context snapshot model of the UI panel of the new version of the application. The UI context snapshot model 614 builds the UI context snapshot model of the UI panel of the new version of the application and sends the UI context snapshot model of the UI panel of the new version of the application to UI re-matcher 616.

UI re-matcher 616 compares the UI context snapshot model of the UI panel of the new version of the application with the UI context snapshot model of the UI panel of the previous version of the application, identifies UI elements in the UI context snapshot model of the new application with similar functionality as UI elements in the UI context snapshot model of the previous application, and provides information for UI context attributes of the identified UI elements with similar functionality in the new version of the application to UI locator 604, which represents UI locator module 226 described with respect to FIG. 2. The UI locator 604 provides the information for UI context attributes of the identified UI elements with similar functionality in the new version of the application to script executor 606. The script executor 606 uses the information for UI context attributes of the identified UI elements to execute the action command referencing the UI element in the new version of the application. The script generator 618, which represents script generator module 234 described with respect to FIG. 2, revises the automation script 610 with the action command referencing the identified UI element in the new version of the application provided by the UI context snapshot model 614. In this way, the present invention provides failover for UI elements during automation execution and provides automatic updates of UI automation in bots for new versions of applications used by bots.

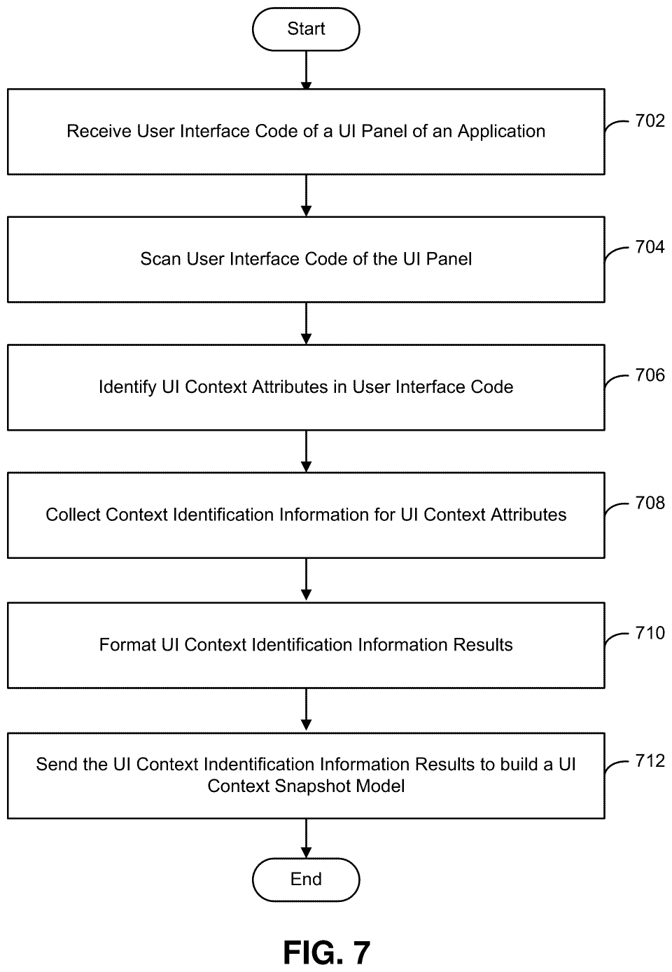

FIGS. 7-9 show flowcharts and/or block diagrams that illustrate the architecture, functionality, and operation of possible implementations of systems, methods, and computer program products according to various embodiments of the present invention. As noted above with respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time. And some blocks shown may be performed and other blocks not performed, depending upon the functionality involved.

FIG. 7 shows a flowchart of an exemplary method in accordance with aspects of the present invention. Steps of the method may be carried out in the environment of FIG. 2 and are described with reference to elements depicted in FIG. 2. In particular, the flowchart of FIG. 7 shows an exemplary method for identifying context attributes of UI elements of an application used by a bot in accordance with aspects of the present invention.

At step 702, the system receives UI code of a UI panel of an application. For example, UI module 222 described with respect to FIG. 2 sends UI code for UI panels of an application in use to the UI context attributes identification module 210 described with respect to FIG. 2. The UI code of the UI panel of an application can be any type of code in embodiments specifying UI elements of a user interface, such as HTML code. In embodiments, and as described with respect to FIG. 2, UI context attributes identification module 210 receives UI code of a UI panel of an application.

At step 704, the system scans the UI code of the UI panel. For example, the system scans HTML code in embodiments specifying the UI elements of the UI panel of the application to identify UI context attributes specified in the HTML code. In embodiments, and as described with respect to FIG. 2, code scan module 212 of UI context attributes identification module 210 scans the UI code of the UI panel of the application.

At step 706, the system identifies UI context attributes specified in the UI code. For instance, the system identifies UI context attributes specified in an HTML document in embodiments such as element type, element coordinate information, element label, element event type, element event handler, element data dependency, element event dependency, element parent relationship, element children relationships, element peer relationships, and element metadata such as style, XPath, Id, tag name, and so forth. In embodiments, and as described with respect to FIG. 2, code scan module 212 of UI context attributes identification module 210 identifies UI context attributes specified in the UI code of the UI panel of the application.

At step 708, the system collects UI context identification information for UI context attributes. For example, the system collects the identified UI context attributes specified in the UI code of the UI panel of the application along with UI panel information and the UI elements relationships to parent, children and peer UI panels for formatting as UI context identification information results. In embodiments, and as described with respect to FIG. 2, code scan module 212 of UI context attributes identification module 210 collects UI context identification information for UI context attributes specified in the UI code of the UI panel of the application.

At step 710, the system formats UI context identification information results. For example, the collected UI context identification information for UI context attributes specified in the UI code of the UI panel of the application is written in a normalized format for input to build a context snapshot model. In embodiments, and as described with respect to FIG. 2, result format module 214 of UI context attributes identification module 210 formats UI context identification information results.

At step 712, the system sends the UI context identification information results to build a context snapshot model. In embodiments, and as described with respect to FIG. 2, result format module 214 of UI context attributes identification module 210 sends the UI context identification information results to UI context snapshot module 216 to build a UI context snapshot model.

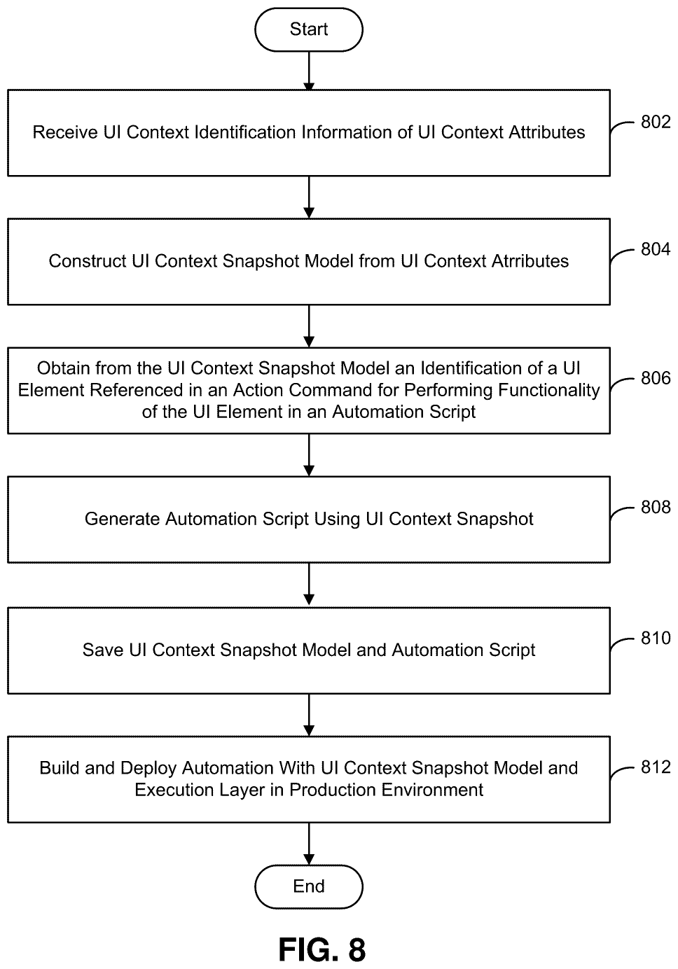

FIG. 8 shows a flowchart of an exemplary method in accordance with aspects of the present invention. Steps of the method may be carried out in the environment of FIG. 2 and are described with reference to elements depicted in FIG. 2. In particular, the flowchart of FIG. 8 shows an exemplary method for building a UI context snapshot model and optimizing generating RPA code using the UI context snapshot model, in accordance with aspects of the present invention.

At step 802, the system receives UI context identification information of UI element attributes. For example, UI context snapshot module 216 described with respect to FIG. 2 receives in embodiments UI context identification information results of formatted UI context attributes specified in the UI code of the UI panel of the application along with UI panel information and the UI elements relationships to parent, children and peer UI panels.

At step 804, the system constructs the UI context snapshot model from UI context identification information of UI element attributes. In embodiments, a representation of the UI context snapshot model is built using UI panel information, UI elements identification information and the UI elements relationships to parent, children and peer UI panels. The UI context snapshot model may be represented in embodiments by a relationship graph of UI elements as nodes connected by edges representing the relationship to other UI elements and/or to UI panels such as parent, child, or peer, for instance. Each node is associated with a template populated with UI context attributes in embodiments such as element coordinate information, element label, element event type, element event handler, element dependency among other context attributes of the UI element. Those skilled in the art should appreciate that other representations of the UI context snapshot model may be implemented in embodiments including a data table of UI element context attributes, an associative array of UI elements and context attributes, or other representation. In embodiments, and as described with respect to FIG. 2, UI context snapshot module 216 with data collector module 218 and constructor module 220 construct the UI context snapshot model from UI context identification information of UI element attributes.

At step 806, the system obtains from the UI context snapshot model an identification of a UI element referenced in an action command for performing functionality of the UI element in an automation script. In embodiments, and as described with respect to FIG. 2, UI context attributes identification module 210, UI context snapshot module 216, UI module 222, UI locator module 226, script loader module 230, UI re-matcher module 232, and script generator module 234 obtain from the UI context snapshot model an identification of a UI element referenced in an action command for performing functionality of the UI element in an automation script. For example, as shown in the process flow diagram of FIG. 5B, an action command referencing a UI element of an application in use may be received by script generator module 234, and UI code of the application in use and referenced by the action command may be sent from UI module 222 to UI locator module 226. Information for UI context attributes of the UI element is sent from UI context snapshot module 216 to UI locator module 226 and to script generator module 234.

At step 808, the system generates an automation script using the UI context snapshot model. In embodiments, and as described with respect to FIG. 2, script generator module 234 uses the information for UI context attributes of the UI element to write script code for performing the action command referencing the UI element in the automation script. In accordance with aspects of the present invention, the UI context snapshot model may be used in this way in embodiments to optimize generating RPA code.

At step 810, the system saves the UI context snapshot model and the automation script. In embodiments, UI context snapshot module 216 as described with respect to FIG. 2 may store the UI context snapshot model in persistent storage 113 as described with respect to FIG. 1. In embodiments, script generator module 234 as described with respect to FIG. 2 may store the automation script in persistent storage 113 as described with respect to FIG. 1. The system may build and deploy the automation in the production environment as described at step 812 below.

At step 812, the system builds and deploys the automation in the production environment. The automation script can be built into a deployable image of the automation, such as RPA bot 236 described with respect to FIG. 2, and the automation can be deployed in the production environment. When the system builds the automation for deployment in the production environment, the build pipeline links and compiles the modules of the execution layer 224, described with respect to FIG. 2, in the deployable image of the automation. Once deployed in the production environment, the UI context snapshot model may further be used in accordance with aspect of the present invention to automate failover of unlocatable UI elements during RPA bot execution by automatically locating updated UI elements in new versions of applications and allowing RPA bots to continue execution when UI elements in previous versions of applications are changed in the new versions of applications.

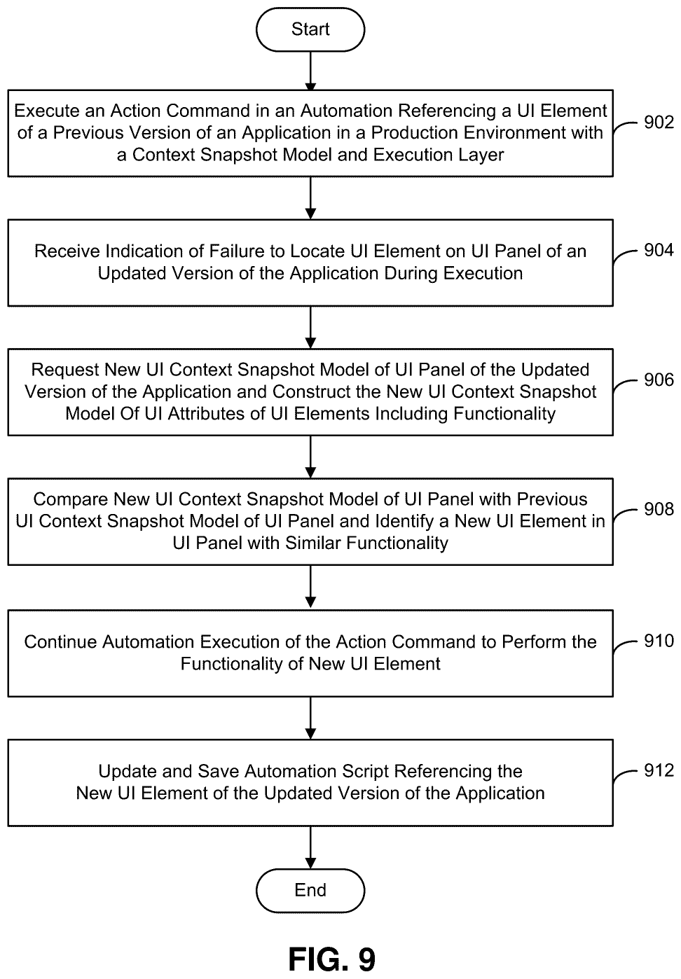

FIG. 9 shows a flowchart of an exemplary method in accordance with aspects of the present invention. Steps of the method may be carried out in the environment of FIG. 2 and are described with reference to elements depicted in FIG. 2. In particular, the flowchart of FIG. 9 shows an exemplary method for automating failover of unlocatable UI elements during RPA bot execution using UI context snapshot models, in accordance with aspects of the present invention.

At step 902, the system executes an action command in the automation referencing a UI element of a previous version of an application in a production environment with the UI context snapshot model and the execution layer of modules of the present invention. When the system builds the automation for deployment in the production environment in embodiments, the build pipeline links and compiles the modules of the execution layer in the deployable image of the automation. As described with respect with FIG. 2, the modules of the execution layer 224 include UI locator module 226, script executor module 228, script loader module 230, UI re-matcher module 232, and script module 234.

At step 904, the system receives an indication of a failure during execution of the automation to locate a UI element on a UI panel of an updated version of the application used by the automation. For example, script executor module 228 described with respect to FIG. 2 may execute an action command in RPA code referencing a UI element of a previous version of an application in embodiments and receive an indication of failure to identify the UI element during execution of the action command in the RPA code that is using an updated version of the application.

At step 906, the system requests a new UI context snapshot model of the UI panel of the updated version of the application and constructs the new UI snapshot model of UI attributes of UI elements including functionality of the UI elements. For example, the script executor module 228 described with respect to FIG. 2 requests UI re-matcher module 232 described with respect to FIG. 2 to find the unidentifiable UI element on the UI panel of the updated version of the application in embodiments. UI re-matcher module 232 requests a new UI context snapshot model of the UI panel of the updated version of the application in embodiments. UI module 222 described with respect to FIG. 2 provides the UI code of the UI panel in embodiments to UI context attributes identification module 210 described with respect to FIG. 2. UI context attributes identification module 210 sends the context attributes of the UI elements on the UI panel to the UI context snapshot module 216 in embodiments to build the UI context snapshot model of the UI panel of the updated version of the application. UI context snapshot module 216 builds the UI context snapshot model of the UI panel of the updated version of the application and sends the UI context snapshot model of the UI panel of the updated version of the application in embodiments to UI re-matcher module 232.

At step 908, the system compares the new UI context snapshot model of the UI panel of the updated version of the application with the UI context snapshot model of the UI panel of the previous version of the application and identifies a new UI element in the UI panel of the updated version of the application with similar functionality. For example, UI re-matcher module 232 described with respect to FIG. 2 compares the UI context snapshot model of the UI panel of the updated version of the application with the UI context snapshot model of the UI panel of the previous version of the application in embodiments, identifies UI elements in the UI context snapshot model of the updated application with similar functionality as UI elements in the UI context snapshot model of the previous application in embodiments, and provides information for UI context attributes of the identified UI elements with similar functionality in the updated version of the application in embodiments to UI locator module 226 described with respect to FIG. 2. UI locator module 226 provides the information for UI context attributes of the identified UI element with similar functionality in the updated version of the application in embodiments to script executor module 228 described with respect to FIG. 2.

At step 910, the system continues automation execution of the action command to perform the functionality of the new UI element. For instance, script executor module 228 described with respect to FIG. 2 uses the information for UI context attributes of the identified UI element with similar functionality in the updated version of the application to execute the action command referencing the UI element of the previous version of an application.

At step 912, the system updates and saves the automation script referencing the new UI element of the updated version of the application. Script generator module 234 described with respect to FIG. 2 revises the automation script in embodiments with the action command referencing the identified UI element in the updated version of the application provided by the UI context snapshot module 216. In embodiments, script generator module 234 may store the automation script in persistent storage 113 as described with respect to FIG. 1.

In this way, embodiments of the present disclosure provide failover for UI elements during automation execution when UI elements in previous versions of applications are changed in new versions of applications and provide automatic updates of UI automation in bots for new versions of applications used by bots. Advantageously, embodiments of the present disclosure also optimize UI automation in generating bots by easily locating UI elements on UI panels of applications via the UI context snapshot model and providing the identification of UI elements for action commands input to a script generator writing RPA code for the action commands.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a processor set, user interface context identification information of attributes of user interface elements in user interface code of an application;
constructing, by the processor set, a model of the attributes of the user interface elements including an attribute indicating functionality of at least one user interface element;
obtaining from the model of the attributes of the user interface elements an identification of the at least one user interface element referenced in an action command for performing the functionality of the at least one user interface element in a robotic process automation code; and
storing, by the processor set, the model of the attributes of the user interface elements in persistent storage.

2. The method of claim 1, further comprising generating, by the processor set, the robotic process automation code referencing the at least one user interface element identified in the model of the attributes of the user interface elements.

3. The method of claim 1, further comprising executing, by the processor set, the robotic process automation code referencing the at least one user interface element identified in the model of the attributes of the user interface elements.

4. The method of claim 1, further comprising:
building, by the processor set, a robotic process automation robot deployable in a production environment using the robotic process automation code; and
deploying, by the processor set, the robotic process automation robot in the production environment.

5. The method of claim 1, further comprising scanning, by the processor set, the user interface code of the application.

6. The method of claim 1, further comprising collecting, by the processor set, the user interface context identification information of the attributes of the user interface elements, including relationships of the user interface elements to parent, children and peer user interface panels.

7. The method of claim 1, further comprising formatting, by the processor set, the user interface context identification information of the attributes of the user interface elements.

8. The method of claim 1, wherein the attributes of the user interface elements in the user interface code of the application are specified by a markup language.

9. The method of claim 1, wherein the attributes of the user interface elements in the user interface code comprise an element type.

10. The method of claim 1, wherein the attributes of the user interface elements in the user interface code comprise an element label.

11. The method of claim 1, wherein the attributes of the user interface elements in the user interface code comprise an element event.

12. The method of claim 1, wherein the attributes of the user interface elements in the user interface code comprise an element dependency.

13. The method of claim 2, further comprising storing, by the processor set, the robotic process automation code in persistent storage.

14. A computer program product comprising one or more computer readable storage media having program instructions collectively stored on the one or more computer readable storage media, the program instructions executable to:
construct a model of attributes of user interface elements in user interface code including an attribute indicating functionality of at least one user interface element;
obtain from the model of the attributes of the user interface elements an identification of the at least one user interface element referenced in an action command for performing the functionality of the at least one user interface element in a robotic process automation code;
generate the robotic process automation code referencing the at least one user interface element identified in the model of the attributes of the user interface elements;
build a robotic process automation robot deployable in a production environment using the generated robotic process automation code; and
deploy the robotic process automation robot in the production environment.

15. The computer program product of claim 14, wherein the program instructions are further executable to:
receive the user interface code specifying the attributes of the user interface elements of a user interface of an application; and
identify the attributes of the user interface elements in the user interface code.

16. The computer program product of claim 14 wherein the program instructions are further executable to collect UI context identification information for the attributes of the user interface elements, including relationships of the user interface elements to parent, children and peer user interface panels.

17. A system comprising:
a processor set, one or more computer readable storage media, and program instructions collectively stored on the one or more computer readable storage media, the program instructions executable to:
execute an action command in a robotic process automation code referencing a user interface element of a previous version of an application;
receive an indication of failure to identify the user interface element during execution of the action command in the robotic process automation code using an updated version of the application;
construct a model of attributes of user interface elements in user interface code of the updated version of the application including an attribute indicating functionality of at least one updated user interface element;
identify from the model of the attributes of the user interface elements the at least one updated user interface element that performs the functionality of the user interface element; and
continue execution of the action command in the robotic process automation code to perform the functionality of the at least one updated user interface element.

18. The system of claim 17, wherein the program instructions are further executable to compare the attributes of the model of the attributes of the user interface elements in the user interface code of the updated version of the application with the attributes of a model of attributes of user interface elements in user interface code of the previous version of the application.

19. The system of claim 17, wherein the program instructions are further executable to update the robotic process automation code to reference the at least one updated user interface element of the updated version of the application.

20. The system of claim 19, wherein the program instructions are further executable to store the robotic process automation code in persistent storage.
